(19) United States
(12) Patent Application Publication
(10) Pub. No.: US 2026/0235759 A1
(43) Pub. Date: Aug. 13, 2026

(54) SYSTEMS AND METHODS FOR IDENTIFYING RAILROAD TRACK RAILS AND DETERMINING RAILROAD TRACK CHARACTERISTICS USING LIDAR

(71) Applicant: BNSF Railway Company, Fort Worth, TX (US)

(72) Inventors: Michael S. Saniei, Fort Worth, TX (US); Ranjan Dash, Flower Mound, TX (US); Yasha Hajizeinalibiouki, Plano, TX (US)

(73) Assignee: BNSF Railway Company, Fort Worth, TX (US)

(21) Appl. No.: 19/051,517

(22) Filed: Feb. 12, 2025

(51) Int. Cl. G01S 17/89; G01B 11/14; G01B 11/24; G01S 17/08

(52) U.S. Cl. CPC G01S 17/89; G01B 11/14; G01B 11/24; G01S 17/08

(57) ABSTRACT

A method for identifying railroad track rails and determining railroad track characteristics using light detection and ranging (LiDAR) includes accessing LiDAR point cloud data comprising locations of objects and surfaces within a railroad track environment. The method further includes identifying, using the LiDAR point cloud data, a plurality of rails of a railroad track within the railroad track environment. The method further includes determining a track centerline point using the identified plurality of rails and determining, using the determined track centerline point, a track characteristic of the railroad track. The method further includes displaying a graphical user interface on an electronic display. The graphical user interface displays an image of the identified plurality of rails and the determined track characteristic of the railroad track.

### TECHNICAL FIELD

The present disclosure relates generally to Light Detection and Ranging (LiDAR), and more particularly to systems and methods for identifying railroad track rails and determining railroad track characteristics using LiDAR.

### BACKGROUND

Railroad transportation systems traverse entire continents to enable the transport and delivery of passengers and goods throughout the world. To enable the efficient and safe operation of railroad transportation systems, a railroad operator utilizes many different hardware and software systems. These systems often rely on accurate data about the railroad system in order to function properly and efficiently. For example, systems that provide clearance for oversized loads being transported by a train may require accurate and precise data regarding the physical locations of rails of railroad tracks and the physical characteristics of the railroad tracks such as track curvature. As another example, systems that analyze ballast and ties of a railroad track may require accurate and precise data regarding the physical locations of rails of railroad tracks and the physical characteristics of the railroad tracks such as the track cross-level.

Typically, railroad track data such as the physical locations of the rails of railroad tracks and the physical characteristics of the railroad tracks such as track curvature and track cross-level may be outdated and imprecise. This may cause software and hardware systems utilized by railroad operators to maintain and operate railroad transportation systems to be inefficient or inaccurate. Furthermore, typical methods of determining the physical locations of the rails of railroad tracks and physical characteristics of the railroad tracks such as track curvature and track cross-level are labor-intensive and may involve manual measurements and guesswork. This may ultimately result in imprecise data and may ultimately cause systems that rely on such data to fail, thereby decreasing the overall efficiency of railroad operations.

### SUMMARY

The present disclosure achieves technical advantages as systems, methods, and computer-readable storage media for automatically identifying railroad track rails and determining railroad track characteristics using Light Detection and Ranging (LiDAR). The functionality for identifying railroad track rails and determining railroad track characteristics is based at least in part on an analysis of LiDAR point cloud data using one or more deep-learning models such as POINTNET. The LiDAR point cloud data is captured by one or more LiDAR instruments that are attached to a rail vehicle as the rail vehicle traverses the railroad track.

In embodiments, the present disclosure provides for a system integrated into a practical application with meaningful limitations as systems, methods, and computer-readable storage media for automatically identifying railroad track rails and determining railroad track characteristics using LiDAR point cloud data for transportation systems such as railroads. In embodiments, a railroad track identification system may be configured to capture LiDAR point cloud data using one or more LiDAR instruments. The railroad track identification system may be further configured to identify, using the LiDAR point cloud data, a plurality of rails of a railroad track within the railroad track environment, determine a track centerline point using the identified plurality of rails, and determine, using the determined track centerline point, a track characteristic of the railroad track. The railroad track identification system may be further configured to display a graphical user interface on an electronic display that permits user review of the identified plurality of rails and the determined track characteristic of the railroad track.

A technical improvement of the features provided herein includes automatically identifying railroad track rails and determining railroad track characteristics using LiDAR point cloud data for transportation systems such as railroads. This rail identification determination process contributes to the overall efficiency of the railroad operations by generating and storing accurate data about railroad tracks that may be used by multiple systems and application. In addition, the system of embodiments can generate alerts and notifications to personnel in order to view identified rails and rail characteristics for a particular segment of railroad track.

Collectively, these technical improvements provided by embodiments of the present disclosure contribute to a more safe, efficient, and reliable railroad operation, capable of handling the complexities of modern freight transportation.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for identifying railroad track rails and determining railroad track characteristics. In doing so, the present disclosure goes well beyond a mere application the manual process to a computer. Accordingly, the disclosure and/or claims herein necessarily provide a technological solution that overcomes a technological problem.

Furthermore, the functionality for automatically identifying railroad track rails and determining railroad track characteristics using LiDAR point cloud data that is provided by the present disclosure represents a specific and particular implementation that results in an improvement in the utilization of a computing system for resource optimization. Thus, rather than a mere improvement that comes about from using a computing system, the present disclosure, in enabling a system to leverage functionality for automatically identifying railroad track rails and determining railroad track characteristics using LiDAR point cloud data, represents features that result in a computing system device that can be used more efficiently and is improved over current systems that do not implement the functionality described herein. As such, the present disclosure and/or claims are directed to patent eligible subject matter.

In embodiments, the present disclosure includes techniques for training models (e.g., machine-learning models, artificial intelligence models, algorithmic constructs, etc.) for performing or executing a designated task or a series of tasks (e.g., one or more features for automatically identifying railroad track rails and determining railroad track characteristics using LiDAR point cloud data in accordance with embodiments of the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical applications that significantly enhance the functionality, reliability, and efficiency of the models developed through these processes.

In embodiments, the present disclosure includes techniques for generating a notification of an event includes generating an alert that includes information specifying the location of a source of data associated with the event, formatting the alert into data structured according to an information format; and transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of automatically identifying railroad track rails and determining railroad track characteristics using LiDAR point cloud data. It is a further object of the disclosure to provide a system for automatically identifying railroad track rails and determining railroad track characteristics using LiDAR point cloud data, and a computer-based tool for automatically identifying railroad track rails and determining railroad track characteristics using LiDAR point cloud data. These and other objects are provided by the present disclosure, including at least the following embodiments.

In one particular embodiment, a system for identifying railroad track rails and determining railroad track characteristics using LiDAR is provided. The system includes one or more LiDAR instruments configured to capture LiDAR point cloud data that indicates locations of objects and surfaces within a railroad track environment. The system further includes one or more memory units configured to store the LiDAR point cloud data. The system further includes one or more computer processors communicatively coupled to the one or more memory units and configured to access the LiDAR point cloud data stored in the one or more memory units. The one or more computer processors are further configured to identify, using the LiDAR point cloud data, a plurality of rails of a railroad track within the railroad track environment. The one or more computer processors are further configured to determine a track centerline point using the identified plurality of rails and to determine, using the determined track centerline point, a track characteristic of the railroad track. The one or more computer processors are further configured to display a graphical user interface on an electronic display. The graphical user interface displays an image of the identified plurality of rails and the determined track characteristic of the railroad track.

In another embodiment, a method for identifying railroad track rails and determining railroad track characteristics using light detection and ranging (LiDAR) includes accessing LiDAR point cloud data comprising locations of objects and surfaces within a railroad track environment. The method further includes identifying, using the LiDAR point cloud data, a plurality of rails of a railroad track within the railroad track environment. The method further includes determining a track centerline point using the identified plurality of rails and determining, using the determined track centerline point, a track characteristic of the railroad track. The method further includes displaying a graphical user interface on an electronic display. The graphical user interface displays an image of the identified plurality of rails and the determined track characteristic of the railroad track.

In yet another embodiment, one or more computer-readable non-transitory storage media embodying instructions is provided. When executed by a processor, the instructions cause the processor to perform operations including accessing LiDAR point cloud data comprising locations of objects and surfaces within a railroad track environment. The operations further include identifying, using the LiDAR point cloud data, a plurality of rails of a railroad track within the railroad track environment. The operations further include determining a track centerline point using the identified plurality of rails and determining, using the determined track centerline point, a track characteristic of the railroad track. The operations further include displaying a graphical user interface on an electronic display. The graphical user interface displays an image of the identified plurality of rails and the determined track characteristic of the railroad track.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a railroad track identification system, according to particular embodiments.

FIG. 2 illustrates LiDAR point cloud data that may be captured and used by the railroad track identification system of FIG. 1, according to particular embodiments.

FIG. 3 illustrates a rail identification module that may be utilized by the railroad track identification system of FIG. 1, according to particular embodiments.

FIG. 4A illustrates rails and a track centerline that have been identified by the rail identification module of FIG. 3, according to particular embodiments.

FIG. 4B illustrates a top-of-rails position that has been identified by the rail identification module of FIG. 3, according to particular embodiments.

FIG. 5 illustrates the calculation of a curvature of a railroad track by the rail identification module of FIG. 3, according to particular embodiments.

FIG. 6 illustrates the calculation of a cross-level of a railroad track by the rail identification module of FIG. 3, according to particular embodiments.

FIG. 7 illustrates a graphical user interface that permits user review of rails and track characteristics identified by the rail identification module of FIG. 3, according to particular embodiments.

FIG. 8 is a chart illustrating a method for identifying railroad track rails and determining railroad track characteristics using LiDAR that may be utilized by the rail identification module of FIG. 3, according to particular embodiments.

FIG. 9 illustrates an example computer system that can be utilized to implement aspects of the various technologies presented herein, according to particular embodiments.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive, may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Railroad transportation systems traverse entire continents to enable the transport and delivery of passengers and goods throughout the world. To enable the efficient and safe operation of railroad transportation systems, a railroad operator utilizes many different hardware and software systems. These systems often rely on accurate data about the railroad system in order to function properly and efficiently. For example, systems that provide clearance for oversized loads being transported by a train may require accurate and precise data regarding the physical locations of rails of railroad tracks and the physical characteristics of the railroad tracks such as track curvature. As another example, systems that analyze ballast and ties of a railroad track may require accurate and precise data regarding the physical locations of rails of railroad tracks and the physical characteristics of the railroad tracks such as the track cross-level.

Typically, railroad track data such as the physical locations of the rails of railroad tracks and the physical characteristics of the railroad tracks such as track curvature and track cross-level may be outdated and imprecise. This may cause software and hardware systems utilized by railroad operators to maintain and operate railroad transportation systems to be inefficient or inaccurate. Furthermore, typical methods of determining the physical locations of the rails of railroad tracks and physical characteristics of the railroad tracks such as track curvature and track cross-level are labor-intensive and may involve manual measurements and guesswork. This may ultimately result in imprecise data and may ultimately cause systems that rely on such data to fail, thereby decreasing the overall efficiency of railroad operations.

To address these and other problems with providing accurate railroad track data such as the physical locations of the rails of railroad tracks and the physical characteristics of the railroad tracks such as track curvature and track cross-level, embodiments of the disclosure provide systems and methods that automatically identify railroad track rails and automatically determine railroad track characteristics using LiDAR. In general, the disclosed embodiments automatically identify railroad track rails and automatically determine railroad track characteristics by analyzing LiDAR point cloud data that is periodically captured by one or more LiDAR sensors attached to a railcar that traverses the railroad track. The disclosed embodiments automatically and efficiently provide accurate data regarding the locations of the rails of the railroad track (e.g., the locations of the tops of the rails, the track centerline, etc.) as well as accurate data regarding physical track characteristics such as track curvature and track cross-level. As a result, software and hardware systems utilized by railroad operators to maintain and operate railroad transportation systems may operate properly and efficiently, thereby increasing the overall efficiency and safety of railroad operations.

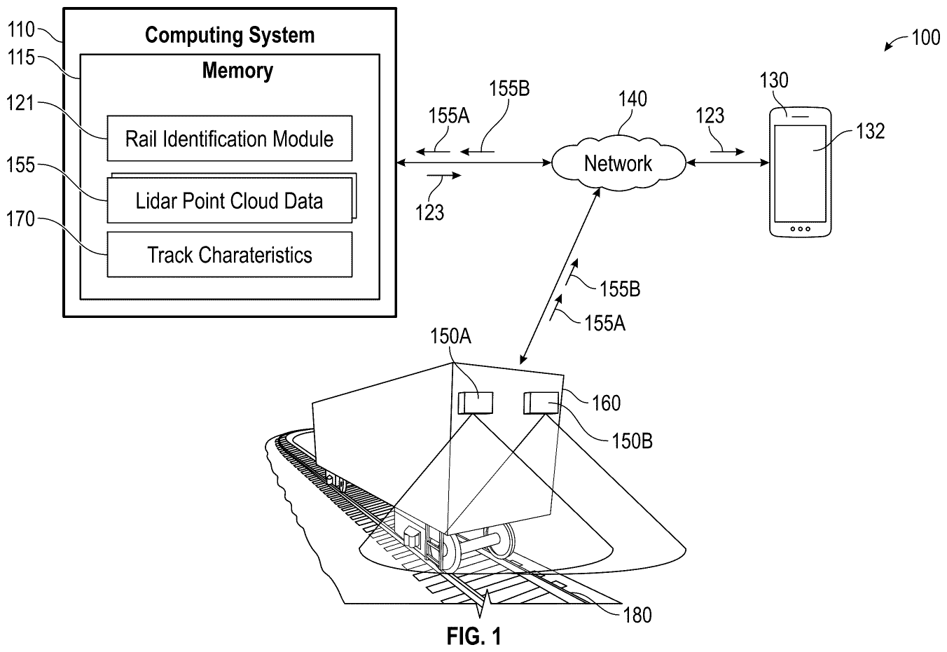

FIG. 1 is a block diagram of an exemplary railroad track identification system 100, according to certain embodiments of the present disclosure. As shown in FIG. 1, certain embodiments of railroad track identification system 100 may include a computing system 110, a rail identification module 121, a client system 130, a network 140, and one or more LiDAR instruments 150 (e.g., 150A-150B). Computing system 110, rail identification module 121, client system 130, and LiDAR instruments 150 are all communicatively coupled with each other using any appropriate wired or wireless communication system or network (e.g., network 140). Computing system 110 includes a computer processor (e.g., processor 902) and memory 115 (e.g., memory 904) that stores rail identification module 121, LiDAR point cloud data 155, and track characteristics 170. Client system 130 includes an electronic display for displaying a user interface 132. These components, and their individual components, may cooperatively operate to provide functionality in accordance with the discussion herein.

It is noted that the functional blocks, and components thereof, of railroad track identification system 100 may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of railroad track identification system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of railroad track identification system 100 are provided for purposes of illustration, rather than by way of limitation and that functionalities described as being provided by different functional blocks may be combined into a single component or may be provided via computing resources disposed in a cloud-based environment accessible over a network, such as network 140.

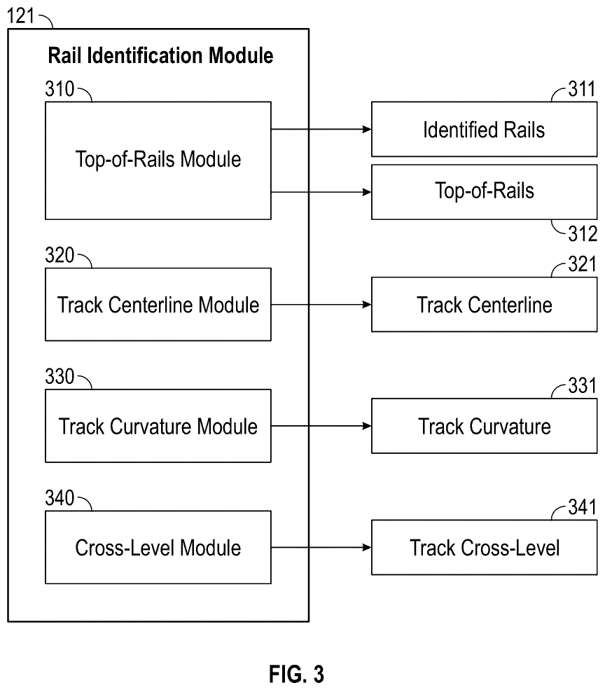

In general, railroad track identification system 100 analyzes LiDAR point cloud data 155 generated by one or more LiDAR instruments 150 coupled to rail vehicle 160 in order to automatically identify rails of railroad track 180 and track characteristics 170 of railroad track 180. LiDAR point cloud data 155 provides locations of points of objects (e.g., railroad track 180) and surfaces within the railroad track environment around railroad track 180. In order to automatically identify rails of railroad track 180 and track characteristics 170 of railroad track 180, some embodiments of railroad track identification system 100 utilize rail identification module 121. Rail identification module 121 analyzes LiDAR point cloud data 155 (e.g., using a deep-learning model) in order to determine the exact physical locations of the rails of railroad track 180. Furthermore, rail identification module 121 analyzes LiDAR point cloud data 155 in order to determine one or more track characteristics 170 of railroad track 180. Track characteristics 170 may include, for example, a curvature of railroad track 180 (e.g., track curvature 331) and a track cross-level of railroad track 180 (e.g., track cross-level 341). The identified rails of railroad track 180 and the determined track characteristics 170 of railroad track 180 may be displayed to a user (e.g., in user interface 132 on client system 130) and may be stored in memory 115 for use by other systems and software applications. For example, the identified rails of railroad track 180 and the determined track characteristics 170 of railroad track 180 may be used systems that provide clearance for oversized loads being transported by a train or by systems that analyze ballast and ties of railroad track 180. Specific embodiments of rail identification module 121 are discussed in more detail below in reference to FIG. 3.

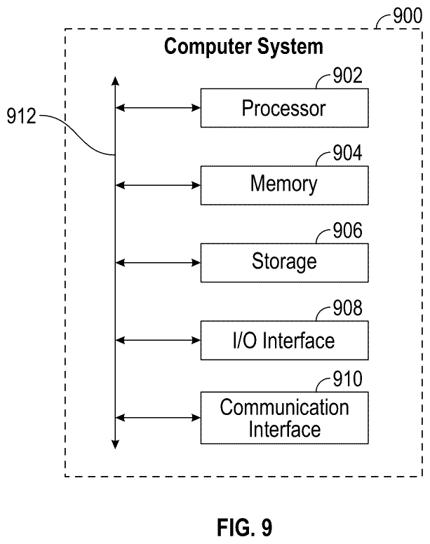

Computing system 110 may be any appropriate computing system in any suitable physical form. As example and not by way of limitation, computing system 110 may be an embedded computer system, a system-on-chip (SOC), a single-board computer system (SBC) (such as, for example, a computer-on-module (COM) or system-on-module (SOM)), a desktop computer system, a laptop or notebook computer system, a mainframe, a mesh of computer systems, a mobile telephone, a personal digital assistant (PDA), a server, a tablet computer system, an augmented/virtual reality device, or a combination of two or more of these. Where appropriate, computing system 110 may include one or more computer systems; be unitary or distributed; span multiple locations; span multiple machines; span multiple data centers; or reside in a cloud, which may include one or more cloud components in one or more networks. Where appropriate, computing system 110 may perform without substantial spatial or temporal limitation one or more steps of one or more methods described or illustrated herein. As an example, and not by way of limitation, computing system 110 may perform in real time or in batch mode one or more steps of one or more methods described or illustrated herein. Computing system 110 may perform at different times or at different locations one or more steps of one or more methods described or illustrated herein, where appropriate. A particular example of a computing system 110 is described in reference to FIG. 9.

Computing system 110 includes one or more memory units/devices 115 (collectively herein, “memory 115”) that may store rail identification module 121. In general, rail identification module 121 identifies rails of railroad track 180 (e.g., identified rails 311, top-of-rails 312, and track centerline 321) and determines track characteristics 170 of railroad track 180 (e.g., track curvature 331 and track cross-level 341). The operation of rail identification module 121 is discussed in more detail below in reference to FIG. 3.

In some embodiments, rail identification module 121 may send one or more electronic alerts 123 (e.g., a text message, a notification, and the like) to client system 130 (e.g., a smartphone, a computer, a tablet, etc.) to notify personnel of outputs of rail identification module 121 (e.g., identified rails 311, top-of-rails 312, track centerline 321, track curvature 331, and track cross-level 341). For example, rail identification module 121 may send an alert 123 to client system 130 that enables a user to view identified rails 311 and track characteristics 170. A user may view the alert and take any appropriate action (e.g., approve or edit identified rails 311 and/or track characteristics 170). As a result, the safety and efficiency of operations of railroad track 180 may be improved.

Client system 130 is any appropriate user device for communicating with components of railroad track identification system 100 over network 140 (e.g., the internet). In particular embodiments, client system 130 may be an electronic device including hardware, software, or embedded logic components or a combination of two or more such components and capable of carrying out the appropriate functionalities implemented or supported by client system 130. As an example, and not by way of limitation, a client system 130 may include a computer system (e.g., computer system 900) such as a desktop computer, notebook or laptop computer, netbook, a tablet computer, e-book reader, GPS device, camera, personal digital assistant (PDA), handheld electronic device, cellular telephone, smartphone, smartwatch, augmented/virtual reality device such as wearable computer glasses, other suitable electronic device, or any suitable combination thereof. This disclosure contemplates any suitable client system 130. A client system 130 may enable a network user at client system 130 to access network 140. A client system 130 may enable a user to communicate with other users at other client systems 130. Client system 130 may include an electronic display that displays graphical user interface 132, a processor such processor 902, and memory such as memory 904.

Network 140 allows communication between and amongst the various components of railroad track identification system 100. This disclosure contemplates network 140 being any suitable network operable to facilitate communication between the components of railroad track identification system 100. Network 140 may include any interconnecting system capable of transmitting audio, video, signals, data, messages, or any combination of the preceding. Network 140 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network.

LiDAR instrument 150 is any LiDAR system or device that is capable of scanning railroad track 180 and the environment around railroad track 180 as rail vehicle 160 traverses railroad track 180. In some embodiments, railroad track identification system 100 includes a single LiDAR instrument 150 that is attached to rail vehicle 160. In other embodiments, railroad track identification system 100 includes two or more LiDAR instruments 150 attached to rail vehicle 160 (e.g., LiDAR instrument 150A, LiDAR instrument 150B, etc.). In general, LiDAR instrument 150 produces LiDAR point cloud data 155 and electronically transmits LiDAR point cloud data 155 to computing system 110 via network 140 (e.g., either directly or via another computing system 110 onboard rail vehicle 160). For example, in embodiments that include two LiDAR instruments 150, a first LiDAR instrument 150A produces LiDAR point cloud data 155A corresponding to one side of rail vehicle 160 (e.g., the left side of rail vehicle 160), and a second LiDAR instrument 150B produces LiDAR point cloud data 155B corresponding to the other side of rail vehicle 160 (e.g., the right side of rail vehicle 160). In some embodiments, LiDAR point cloud data 155A may overlap with LiDAR point cloud data 155B (i.e., both LiDAR point cloud data 155A and LiDAR point cloud data 155B may cover an overlapping center portion of railroad track 180 as illustrated).

In embodiments that include more than one LiDAR instrument 150, some embodiments of railroad track identification system 100 may combine and filter multiple LiDAR point cloud data 155 in order to remove noise or false points. For example, railroad track identification system 100 may combine LiDAR point cloud data 155 from multiple LiDAR instruments 150 (e.g., LiDAR instrument 150A and LiDAR instrument 150B) and then remove any points that are unique to only one data set. As a specific example, if a particular data point is included in LiDAR point cloud data 155A but is not included in LiDAR point cloud data 155B, that particular data point may be considered noise or a false data point and may be removed by railroad track identification system 100. As used herein, any reference to analyzing LiDAR point cloud data 155 may refer to analyzing data from a single LiDAR instrument 150 or to analyzing combined/filtered data from multiple LiDAR instruments 150.

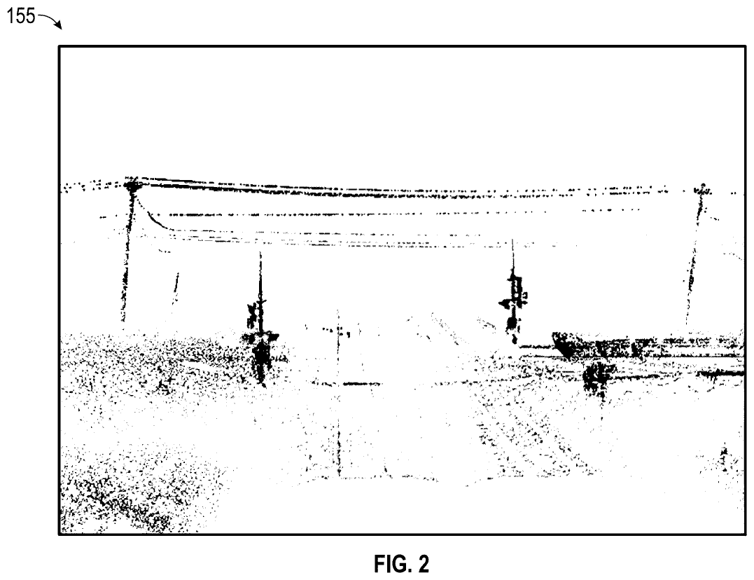

LiDAR point cloud data 155 is data captured by LiDAR instrument 150 while rail vehicle 160 traverses railroad track 180. A particular example of LiDAR point cloud data 155 is illustrated in FIG. 2. In some embodiments, LiDAR point cloud data 155 captured by LiDAR instrument 150 indicates the locations of objects and surfaces within a railroad track environment (e.g., railroad track 180, the physical area surrounding railroad track 180, and the like). Each data point within LiDAR point cloud data 155 may have an associated set of coordinates that spatially locate the point in a three-dimensional environment. The data points within LiDAR point cloud data 155 are analyzed by rail identification module 121 in order to determine identified rails 311, top-of-rails 312, and/or track characteristics 170, as described in more detail below.

Rail vehicle 160 is any appropriate vehicle or object that is able to traverse railroad track 180. In some embodiments, for example, rail vehicle 160 may be a railcar or a locomotive of a train. In other embodiments, rail vehicle 160 may be any other appropriate vehicle (e.g., an automobile) that is configured to traverse railroad track 180.

In operation, railroad track identification system 100 utilizes rail identification module 121 to analyze LiDAR point cloud data 155 generated by one or more LiDAR instruments 150 in order to automatically identify rails of railroad track 180 (e.g., identified rails 311, top-of-rails 312, and track centerline 321) and track characteristics 170 (e.g., track curvature 331 and track cross-level 341) of railroad track 180. To do so, railroad track identification system 100 first captures LiDAR point cloud data 155 using one or more LiDAR instruments 150 attached to rail vehicle 160. If LiDAR point cloud data 155 is captured by two or more LiDAR instruments 150, LiDAR point cloud data 155 may be filtered by railroad track identification system 100 to eliminate data points that are only in a single data set. Next, rail identification module 121 analyzes LiDAR point cloud data 155 using a deep-learning model such as POINTNET in order to identify the exact physical locations of the rails of railroad track 180. Specific methods of identifying the rails of railroad track 180 are discussed in more detail below in reference to top-of-rails module 310. In some embodiments, identifying the rails of railroad track 180 includes generating identified rails 311 and top-of-rails 312.

After identifying the rails of railroad track 180, some embodiments of railroad track identification system 100 determine one or more track centerline points (e.g., track centerline points 322) and a track centerline (e.g., track centerline 321) of railroad track 180. Specific methods of determining the track centerline points and the track centerline are discussed in more detail below in reference to track centerline module 320. Next, some embodiments of rail identification module 121 use the determined track centerline points to determine one or more track characteristics 170 of railroad track 180. The track characteristics 170 may include track curvature 331 and track cross-level 341. Specific methods of determining track curvature 331 are discussed in more detail below in reference to track curvature module 330, and specific methods of determining track cross-level 341 are discussed in more detail below in reference to cross-level module 340.

Once railroad track identification system 100 identifies the rails of railroad track 180 and determines track characteristics 170 of railroad track 180, railroad track identification system 100 may display the rails of railroad track 180 and track characteristics 170 of railroad track 180 to a user in a user interface (e.g., in user interface 132 on client system 130). In addition, railroad track identification system 100 may store information about the rails of railroad track 180 and track characteristics 170 of railroad track 180 in memory 115 for use by other systems and software applications. For example, the identified rails of railroad track 180 and the determined track characteristics 170 of railroad track 180 may be used systems that provide clearance for oversized loads being transported by a train or by systems that analyze ballast and ties of railroad track 180.

FIG. 3 illustrates a rail identification module 121 that may be utilized by railroad track identification system 100, according to particular embodiments. Rail identification module 121 may be a software module/application that is utilized by railroad track identification system 100 to analyze LiDAR point cloud data 155 in order to identify rails of railroad track 180 (e.g., identified rails 311, top-of-rails 312, track centerline 321) and to determine track characteristics 170 (e.g., track curvature 331 and track cross-level 341) of railroad track 180, as described in more detail below. Rail identification module 121 represents any suitable set of instructions, logic, or code embodied in a computer-readable storage medium. For example, rail identification module 121 may be embodied in memory 115, a disk, a CD, or a flash drive. In particular embodiments, rail identification module 121 may include instructions (e.g., a software application) executable by a computer processor to perform some or all of the functions described herein. In some embodiments, rail identification module 121 includes a top-of-rails module 310, a track centerline module 320, a track curvature module 330, and a cross-level module 340, as described in more detail below.

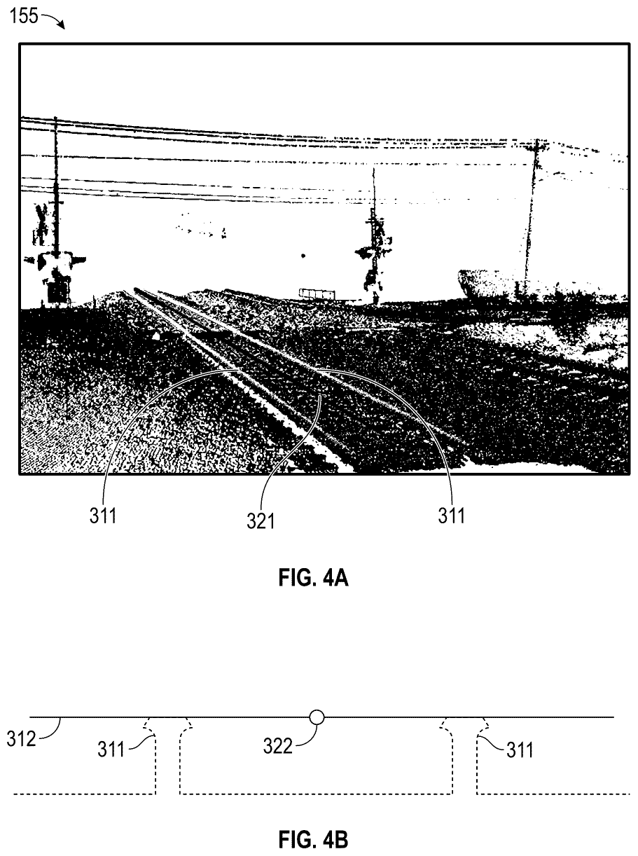

Top-of-rails module 310 is a software module/application (either standalone or included within rail identification module 121) that analyzes LiDAR point cloud data 155 and generates identified rails 311 of railroad track 180 and top-of-rails 312 of the identified rails 311. Examples of identified rails 311 and top-of-rails 312 are illustrated in FIGS. 4A and 4B. In general, identified rails 311 are the main rails of railroad track 180 in a scene within LiDAR point cloud data 155, and top-of-rails 312 is the top portion or surface of the identified rails 311. In some embodiments, top-of-rails module 310 utilizes an advanced deep neural network to analyze LiDAR point cloud data 155 in order to determine identified rails 311 and top-of-rails 312 of railroad track 180 within LiDAR point cloud data 155. As a specific example, some embodiments of track centerline module 1210 utilize the deep-learning model POINTNET to analyze LiDAR point cloud data 155 in order to determine identified rails 311 and top-of-rails 312 of railroad track 180 within LiDAR point cloud data 155.

Track centerline module 320 is a software module/application (either standalone or included within rail identification module 121) that determines a track centerline 321 of railroad track 180. An example of track centerline 321 is illustrated in FIG. 4A. In general, track centerline module 320 utilizes identified rails 311 and/or top-of-rails 312 generated by top-of-rails module 310 to first identify a track centerline point 322 at a predetermined interval along railroad track 180. As a specific example, some embodiments of track centerline module 320 locate track centerline point 322 (illustrated in FIG. 4B) along top-of-rails 312 in the middle of the identified rails 311 (i.e., at the midpoint between the identified rails 311). This process may be repeated by track centerline module 320 for any appropriate interval (e.g., a predetermined interval or user-selected interval) along railroad track 180 in order to generate track centerline 321. For example, track centerline points 322 may be created by track centerline module 320 every foot along railroad track 180 in order to generate track centerline 321.

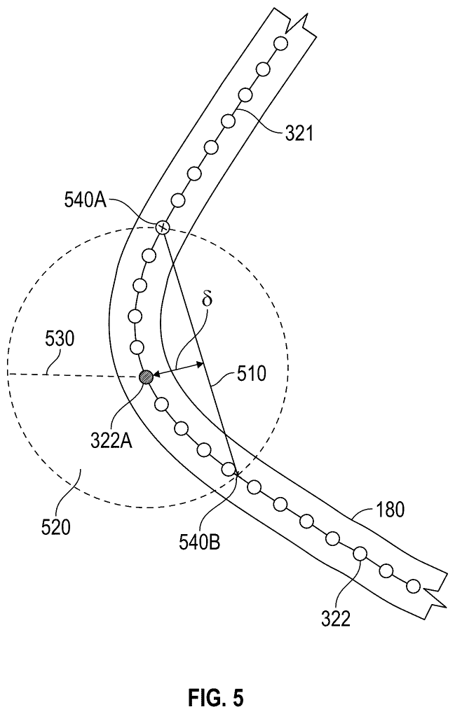

Track curvature module 330 is a software module/application (either standalone or included within rail identification module 121) that determines a track curvature 331 of railroad track 180. An example of how some embodiments of track curvature module 330 determine track curvature 331 is illustrated in FIG. 5. In some embodiments, track curvature 331 (κ) is calculated by track curvature module 330 at each track centerline point 322 (as determined by track centerline module 320) using a virtual chord 510. In some embodiments, virtual chord 510 has a standard fixed length and is moved along track centerline 321 of railroad track 180. At each position, the distance δ between the middle of virtual chord 510 and the centerline of the track is measured. This distance (δ) is linearly converted to the curvature 331 of the track at that point using the equation: κ=αδ, where α is a constant whose sign value is based on the direction of the curvature with respect to the ascending milepost direction (e.g., −5.5 or +5.5). In other embodiments, a circular buffer 520 of a predetermined radius 530 is used to calculate track curvature 331. In these embodiments, circular buffer 520 with predetermined radius 530 (e.g., 25 m) is created at each track centerline point 322 of interest. For example, as illustrated in FIG. 5, circular buffer 520 is created at centerline point 322A. Next, track curvature module 330 finds the intersections 540A and 540B of circular buffer 520 with track centerline 321. Next, track curvature module 330 connects intersections 540A and 540B to create virtual chord 510. Track curvature module 330 then calculates distance δ (e.g., in meters) between centerline point 322A and virtual chord 510. Track curvature 331 at centerline point 322A may then be calculated by track curvature module 330 using the equation: κ=αδ, where α is a constant whose sign value is based on the direction of the curvature with respect to the ascending milepost direction (e.g., −5.5 or +5.5).

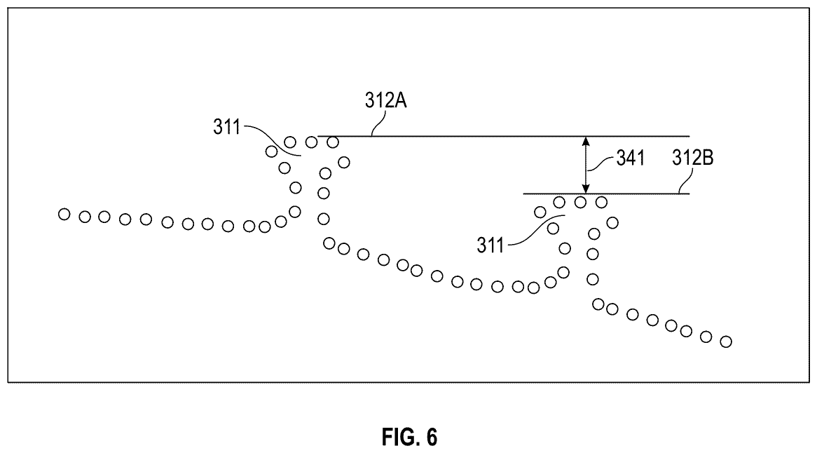

Cross-level module 340 is a software module/application (either standalone or included within rail identification module 121) that determines a track cross-level 341 of railroad track 180. An example of how some embodiments of cross-level module 340 determine track cross-level 341 is illustrated in FIG. 6. In some embodiments, cross-level module 340 first creates a cross section of LiDAR point cloud data 155 at each track centerline point 322 and then reprojects all of the surrounding point cloud data over a 2D plane as illustrated in FIG. 6. Next, cross-level module 340 finds top-of-rails 312A and 312B for each of the identified rails 311 as described above with respect to top-of-rails module 310. Cross-level module 340 then calculates track cross-level 341 as the distance between top-of-rails 312A and top-of-rails 312B.

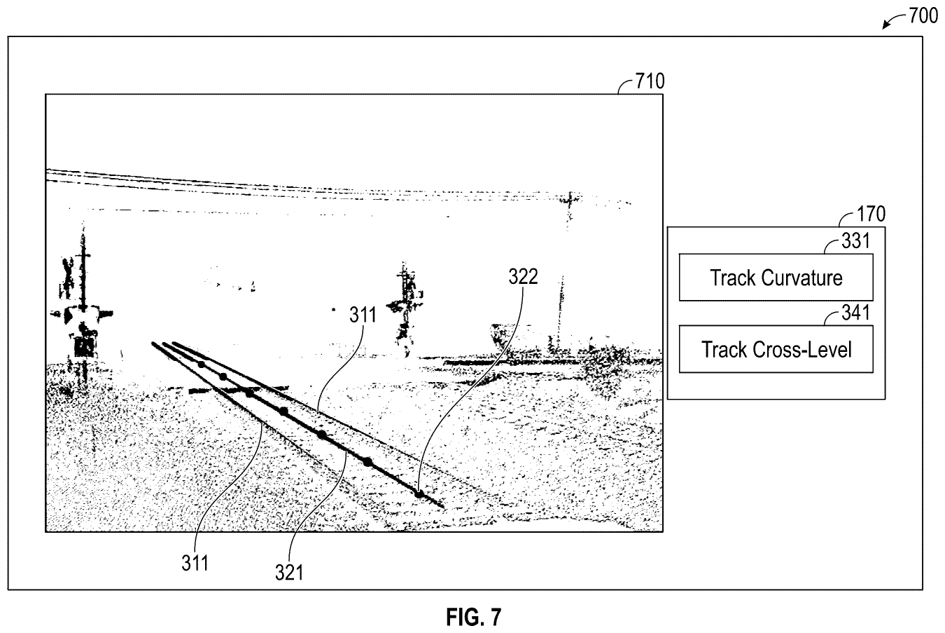

FIG. 7 illustrates a graphical user interface 700 that may permit user review of identified rails 311 and track characteristics 170 identified by rail identification module 121, according to particular embodiments. As illustrated in FIG. 7, some embodiments of graphical user interface 700 display an image 710 and track characteristics 170. In general, image 710 displays the rails of railroad track 180 (e.g., identified rails 311) that are identified by rail identification module 121 as described above. In some embodiments, image 710 is an actual photograph of railroad track 180 (e.g., taken by a camera mounted to rail vehicle 160 such as a 360-degree camera). In other embodiments, image 710 is a cropped portion of LiDAR point cloud data 155 (either 2D or 3D) that includes identified rails 311. In some embodiments, identified rails 311 are highlighted within image 710. For example, identified rails 311 may be highlighted using a different color, texture, symbol, etc. from their surroundings. Similarly, track centerline 321 and/or track centerline points 322 may be displayed within image 710. In these embodiments, track centerline 321 and/or track centerline points 322 may also be highlighted using a different color, texture, symbol, etc. from their surroundings.

In some embodiments, graphical user interface 700 displays track characteristics 170 (e.g., track curvature 331 and track cross-level 341) that are determined by rail identification module 121. In some embodiments, the track characteristics 170 displayed in graphical user interface 700 correspond to a particular track centerline point 322. For example, the displayed track characteristics 170 may correspond to a particular track centerline point 322 that is located at or near the center of image 710. As another example, a user may be provided with a user-selected element in order to select a particular track centerline point 322 within image 710, and the displayed track characteristics 170 may correspond to the user-selected track centerline point 322.

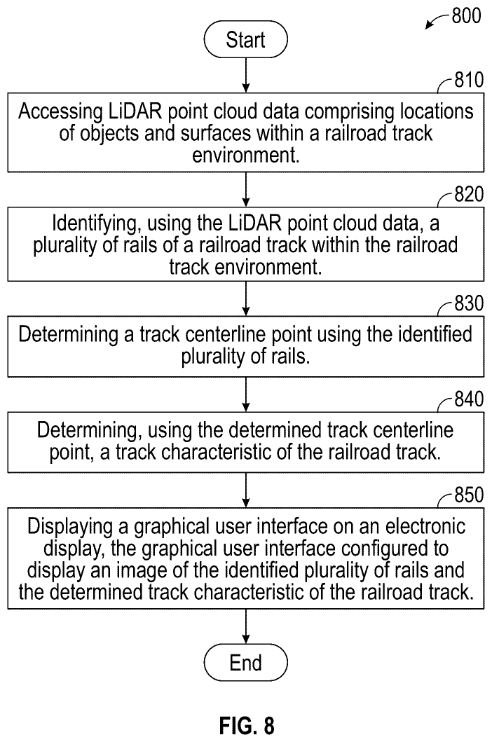

FIG. 8 is a chart illustrating a method 800 for identifying railroad track rails and determining railroad track characteristics using LiDAR, according to particular embodiments. In some embodiments, method 800 may be performed by rail identification module 121 of railroad track identification system 100. At step 810, method 800 accesses LiDAR point cloud data stored in one or more memory units. In some embodiments, the LiDAR point cloud data includes locations of objects and surfaces within a railroad track environment. In some embodiments, the LiDAR point cloud data is LiDAR point cloud data 155. In some embodiments, the LiDAR point cloud data 155 is generated by one or more LiDAR instruments attached to a rail vehicle. In some embodiments, the one or more LiDAR instruments are LiDAR instruments 150.

At step 820, method 800 identifies, using the LiDAR point cloud data of step 810, a plurality of rails of a railroad track within the railroad track environment. In some embodiments, step 820 is performed by top-of-rails module 310. In some embodiments, the identified plurality of rails of the railroad track are identified rails 311. In some embodiments, step 820 includes utilizing a deep-learning model such as POINTNET. In some embodiments, method 800 additionally or alternatively determines top-of-rails 312 in step 820.

At step 830, method 800 determines a track centerline point using the identified plurality of rails of step 820. In some embodiments, the track centerline point is track centerline point 322. In some embodiments, step 830 is performed by track centerline module 320. In some embodiments, the track centerline point is placed in step 830 along top-of-rails 312 in the middle of the identified rails 311 (i.e., at the midpoint between the identified rails 311). In some embodiments, step 830 may additionally include determining a track centerline. In some embodiments, the track centerline may be track centerline 321. In some embodiments, the track centerline may be created by first creating a track centerline point at every predetermined distance along the railroad track (e.g., every foot). Next, the track centerline may be created by connecting the multiple track centerline points along the railroad track.

At step 840, method 800 determines, using the determined track centerline point, a track characteristic of the railroad track. In some embodiments, the track characteristic is a track characteristic 170. In some embodiments, the track characteristic is a track curvature. In some embodiments, the track curvature is track curvature 331 that is determined by track curvature module 330. In some embodiments, the track curvature is determined by first determining a virtual chord and then calculating a distance between the track centerline point of step 830 and the virtual chord. The track curvature may then be calculated based on the calculated distance between the track centerline point of step 830 and the virtual chord. For example, track curvature may be calculated by multiplying the distance between the track centerline point of step 830 and the virtual chord by a constant whose sign value is based on the direction of the curvature with respect to the ascending milepost direction (e.g., −5.5 or +5.5).

In some embodiments, the track characteristic of step 840 is a track cross-level. In some embodiments, the track cross-level is track cross-level 341 that is determined by cross-level module 340. In some embodiments, the track cross-level is determined by first generating a cross section of the LiDAR point cloud data of step 810 at the track centerline point. Next, a top-of-rails 312 is determined from the cross-section for each of the identified plurality of rails (e.g., a top-of-rails 312A for the left rail and a top-of-rails 312B for the right rail). Finally, the track cross-level is determined by calculating the distance between the top-of-rails for each of the identified plurality of rails (e.g., the distance between top-of-rails 312A for the left rail and top-of-rails 312B for the right rail).

At step 850, method 800 displays a graphical user interface on an electronic display. In some embodiments, the graphical user interface is graphical user interface 700. In some embodiments, the electronic display is client system 130. In some embodiments, the graphical user interface is configured to display an image of the identified plurality of rails of step 820 and the determined track characteristic of the railroad track of step 840. In some embodiments, the image is image 710. In some embodiments, the image is a cropped portion of the LiDAR point cloud data that includes the identified plurality of rails. In some embodiments, the identified plurality of rails are highlighted in the image. In some embodiments, the image includes the track centerline point(s) and/or a track centerline. After step 850, method 800 may end.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method including the particular steps of the method of FIG. 8, this disclosure contemplates any suitable method including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

FIG. 9 illustrates an example computer system 900 that can be utilized to implement aspects of the various methods and systems presented herein, according to particular embodiments. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example, and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example, and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example, and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example, and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example, and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example, and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in the included FIGURES may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system for identifying railroad track rails and determining railroad track characteristics using light detection and ranging (LiDAR), the system comprising:
one or more LiDAR instruments configured to capture LiDAR point cloud data comprising locations of objects and surfaces within a railroad track environment;
one or more memory units configured to store the LiDAR point cloud data; and
one or more computer processors communicatively coupled to the one or more memory units and configured to:
access the LiDAR point cloud data stored in the one or more memory units;
identify, using the LiDAR point cloud data, a plurality of rails of a railroad track within the railroad track environment;
determine a track centerline point using the identified plurality of rails;
determine, using the determined track centerline point, a track characteristic of the railroad track; and
display a graphical user interface on an electronic display, the graphical user interface configured to display:
an image of the identified plurality of rails; and
the determined track characteristic of the railroad track.

2. The system of claim 1, wherein identifying, using the LiDAR point cloud data, the plurality of rails of the railroad track within the railroad track environment comprises utilizing a deep-learning model.

3. The system of claim 1, wherein the image of the identified plurality of rails comprises a cropped portion of the LiDAR point cloud data that includes the identified plurality of rails, wherein the identified plurality of rails are highlighted in the cropped portion of the LiDAR point cloud.

4. The system of claim 1, the one or more computer processors further configured to:
determine multiple additional track centerline points along the railroad track using the identified plurality of rails; and
determine a track centerline using the track centerline point and the multiple additional track centerline points, wherein the image of the identified plurality of rails comprises the track centerline.

5. The system of claim 1, wherein:
the track characteristic of the railroad track comprises a track curvature; and
determining the track characteristic of the railroad track comprises calculating the track curvature by:
determining a virtual chord;
calculating a distance between the virtual chord and the track centerline point; and
calculating the track curvature based on the distance between the virtual chord and the track centerline point.

6. The system of claim 1, wherein:
the track characteristic of the railroad track comprises a track cross-level; and
determining the track characteristic of the railroad track comprises calculating the track cross-level by:
generating a cross-section of the LiDAR point cloud data at the track centerline point;
determining, by analyzing the cross-section, a first top-of rails for a left rail of the identified plurality of rails;
determining, by analyzing the cross-section, a second top-of rails for a right rail of the identified plurality of rails; and
calculating a distance between the first top-of-rails and the second top-of-rails.

7. The system of claim 1, wherein determining the track centerline point using the identified plurality of rails comprises:
determining a top-of-rails for the identified plurality of rails; and
locating the track centerline point along the top-of-rails at a midpoint between the identified plurality of rails.

8. A method by a computing system for identifying railroad track rails and determining railroad track characteristics using light detection and ranging (LiDAR), the method comprising:
accessing LiDAR point cloud data stored in one or more memory units, the LiDAR point cloud data comprising locations of objects and surfaces within a railroad track environment;
identifying, using the LiDAR point cloud data, a plurality of rails of a railroad track within the railroad track environment;
determining a track centerline point using the identified plurality of rails;
determining, using the determined track centerline point, a track characteristic of the railroad track; and
displaying a graphical user interface on an electronic display, the graphical user interface configured to display:
an image of the identified plurality of rails; and
the determined track characteristic of the railroad track.

9. The method of claim 8, wherein identifying, using the LiDAR point cloud data, the plurality of rails of the railroad track within the railroad track environment comprises utilizing a deep-learning model.

10. The method of claim 8, wherein the image of the identified plurality of rails comprises a cropped portion of the LiDAR point cloud data that includes the identified plurality of rails, wherein the identified plurality of rails are highlighted in the cropped portion of the LiDAR point cloud.

11. The method of claim 8, further comprising:
determining multiple additional track centerline points along the railroad track using the identified plurality of rails; and
determining a track centerline using the track centerline point and the multiple additional track centerline points, wherein the image of the identified plurality of rails comprises the track centerline.

12. The method of claim 8, wherein:
the track characteristic of the railroad track comprises a track curvature; and
determining the track characteristic of the railroad track comprises calculating the track curvature by:
determining a virtual chord;
calculating a distance between the virtual chord and the track centerline point; and
calculating the track curvature based on the distance between the virtual chord and the track centerline point.

13. The method of claim 8, wherein:
the track characteristic of the railroad track comprises a track cross-level; and
determining the track characteristic of the railroad track comprises calculating the track cross-level by:
generating a cross-section of the LiDAR point cloud data at the track centerline point;
determining, by analyzing the cross-section, a first top-of rails for a left rail of the identified plurality of rails;
determining, by analyzing the cross-section, a second top-of rails for a right rail of the identified plurality of rails; and
calculating a distance between the first top-of-rails and the second top-of-rails.

14. The method of claim 8, wherein determining the track centerline point using the identified plurality of rails comprises:
determining a top-of-rails for the identified plurality of rails; and
locating the track centerline point along the top-of-rails at a midpoint between the identified plurality of rails.

15. One or more computer-readable non-transitory storage media embodying instructions that, when executed by a processor, cause the processor to perform operations comprising:
accessing light detection and ranging (LiDAR) point cloud data stored in one or more memory units, the LiDAR point cloud data comprising locations of objects and surfaces within a railroad track environment;
identifying, using the LiDAR point cloud data, a plurality of rails of a railroad track within the railroad track environment;
determining a track centerline point using the identified plurality of rails;
determining, using the determined track centerline point, a track characteristic of the railroad track; and
displaying a graphical user interface on an electronic display, the graphical user interface configured to display:
an image of the identified plurality of rails; and
the determined track characteristic of the railroad track.

16. The one or more computer-readable non-transitory storage media of claim 15, wherein identifying, using the LiDAR point cloud data, the plurality of rails of the railroad track within the railroad track environment comprises utilizing a deep-learning model.

17. The one or more computer-readable non-transitory storage media of claim 15, wherein the image of the identified plurality of rails comprises a cropped portion of the LiDAR point cloud data that includes the identified plurality of rails, wherein the identified plurality of rails are highlighted in the cropped portion of the LiDAR point cloud.

18. The one or more computer-readable non-transitory storage media of claim 15, the operations further comprising:
determining multiple additional track centerline points along the railroad track using the identified plurality of rails; and
determining a track centerline using the track centerline point and the multiple additional track centerline points, wherein the image of the identified plurality of rails comprises the track centerline.

19. The one or more computer-readable non-transitory storage media of claim 15, wherein:
the track characteristic of the railroad track comprises a track curvature; and
determining the track characteristic of the railroad track comprises calculating the track curvature by:
determining a virtual chord;
calculating a distance between the virtual chord and the track centerline point; and
calculating the track curvature based on the distance between the virtual chord and the track centerline point.

20. The one or more computer-readable non-transitory storage media of claim 15, wherein:
the track characteristic of the railroad track comprises a track cross-level; and
determining the track characteristic of the railroad track comprises calculating the track cross-level by:
generating a cross-section of the LiDAR point cloud data at the track centerline point;
determining, by analyzing the cross-section, a first top-of rails for a left rail of the identified plurality of rails;
determining, by analyzing the cross-section, a second top-of rails for a right rail of the identified plurality of rails; and
calculating a distance between the first top-of-rails and the second top-of-rails.
